(19) United States
(12) Patent Application Publication
(10) Pub. No.: US 2019/0240646 A1
(43) Pub. Date: Aug. 8, 2019

(54) MESOPOROUS MANGANESE FERRITE FENTON-LIKE CATALYST, PREPARATION METHOD THEREFOR, AND APPLICATION THEREOF

(71) Applicant: Nanjing University, Nanjing (CN)

(72) Inventors: Jinnan WANG, Nanjing (CN); Suqian XU, Nanjing (CN); Ning SHAO, Nanjing (CN)

(21) Appl. No.: 16/328,266

(22) PCT Filed: Jun. 22, 2017
(86) PCT No.: PCT/CN2017/089467

§ 371 Date: Feb. 25, 2019

(30) Foreign Application Priority Data
Sep. 9, 2016 (CN) 201610812319.3

(51) Int. Cl. B01J 23/889; B01J 35/10; B01J 37/00; B01J 37/08; B01J 37/04; B01J 37/06; C02F 1/72; C01G 49/00

(52) U.S. Cl. CPC B01J 23/8892; C02F 2101/38; B01J 35/1061; B01J 35/1038; B01J 37/0018; B01J 37/08; B01J 37/04; B01J 37/009; B01J 37/06; C02F 1/722; C02F 1/725; C01G 49/0072; C01P 2004/03; C01P 2002/72; C02F 2305/026; B01J 35/1019

(57) ABSTRACT

The present invention discloses a mesoporous manganese ferrite Fenton-like catalyst and preparation method and application thereof and pertains to the field of preparation of Fenton-like catalysts. The present invention uses KIT-6 as a hard template agent to synthesize mesoporous manganese ferrite catalyst. The prepared mesoporous manganese ferrite and hydrogen peroxide constitute a Fenton-like system oxidation wastewater treatment system to carry out efficient removal and mineralization of organic pollutants in wastewater. The preparation method of the present invention is simple and efficient. The prepared Fenton-like catalyst has a mesoporous structure and a relatively large specific surface area. It can provide more adsorption sites and catalytic site and efficiently degrade pollutants in a wide pH range (acidic, neutral and even alkaline) and solves the problem that conventional Fenton reaction occurs only under an acidic condition and a large amount of iron sludge is generated during reaction, causing secondary pollution. Further, the catalyst can be used cyclically and easily separated from the water solution and recovered after use.

### TECHNICAL FIELD

The present invention relates to a Fenton-like catalyst, particularly to a mesoporous manganese ferrite Fenton-like catalytic material and its preparation method and application, uses mesoporous molecular sieve KIT-6 (Porous Si) as a hard template and synthesizes mesoporous MnFe₂O₄ Fenton-like catalyst by impregnation method.

### BACKGROUND TECHNOLOGIES

Fenton-like technology is an advanced oxidation water treatment technology that has been often studied in the recent years. The hydroxyl radical generated in the reaction system is second to oxyfluoride in terms of oxidation in water and has high activity and no selectivity and can effectively degrade the organic pollutants that can be hardly degraded by microorganisms. Many scholars have carried out a lot of research on iron-based metal oxides as Fenton-like catalysts and made remarkable progress, but the iron-based metal oxides in existing researches and applications have the following defects when they are used as iron-based metal oxides:

(1) It is reported in the existing literature that iron ore type Fenton-like catalysts degrade pollutants much more slowly than conventional Fenton method does under the same conditions.

(2) Many unmodified iron oxides can oxidize and degrade organic matters only under an acidic condition and are not suitable for neutral or alkaline wastewater.

(3) Some iron oxides have magnetism and are liable to agglomeration, thereby reducing exposure of active sites and going against catalyst' efficient degradation of pollutants.

In the recent years, some scholars discovered during research that the doping of transition metals in iron-based metal oxides can have a bimetal synergistic effect and raise the catalytic efficiency of the catalyst to some extent, but it still have the following defects in the aspects of preparation method and practice:

(1) The bimetal oxide Fenton-like reagents prepared by the existing synthetic method show fewer pore passages and a smaller specific surface area in morphology. The foregoing morphology is not conducive to the improvement of catalytic efficiency;

(2) The doping of some transition metals in iron-based oxides has a negative impact on the actual catalytic performance. It is reported in literature that the doping of Ni (II) or Ti (V) inhibits the generation rate of hydroxyl radical to some extent;

(3) Most of the doped bimetal oxides are unable to effectively extend the applicable pH range of Fenton-like catalytic reactions and still have to be used under an acidic condition.

The existing relevant patents are as follows:

Comparison published patent 1: Preparation of a Fe—Co Fenton-like catalyst and its products and application. Patent application number: 20130533050.1. This patent chooses FeCl₂.4H₂O and CoCl₂.6H₂O as reaction precursors, KBH₄ as a reaction reducing agent and PVP as a surface protecting agent, adopts a liquid phase reduction method and obtains a product through reaction, aging, suction filtration, washing and vacuum drying. The Fe—Co Fenton-like catalyst obtained by this method can reduce COD_{cr} in the industrial wastewater containing acrylon by more than 60% in a short time and remove more than 70% of the COD_{cr} in the dye wastewater, but this patent has the following defects: (1) In the preparation process of catalyst, the pH value of reaction must be strictly controlled and the operating conditions are complex. (2) In the reaction process, a large amount of hydrogen peroxide is added, so the operation cost is high; (3) In the reaction process, pH is controlled in the range of 2.0±0.5. Under this pH condition, many iron and cobalt ions are separated out, resulting in a large amount of iron sludge, reducing the active ions of the catalyst and subsequently affecting the reusability of the catalyst.

Comparison published patent 2: Preparation of a Cu-doped MnO₂ mesoporous material and its application in Fenton-like water treatment and advanced oxidation technology. Application number: 201510234344.3. This patent provides a method for preparing Cu-doped MnO₂ mesoporous material, which is powder and mainly made from KMnO₄, CuSO₄.5H₂O and maleic acid. The material is applied to treat and degrade the wastewater containing benzotriazole. The doped mesoporous material in this patent is synthesized by dropwise adding maleic acid as a reducing agent to the precursor solution to reduce manganese element in potassium permanganate and then going through washing, drying and calcinations. The foregoing preparation process has two obvious defects: (1) The precursor is simply mixed in a form of salt solution, after subsequent agitation, aging, calcinations and other steps, it is difficult to form a uniform mesoporous structure and effectively distribute doping Cu in the pore passages. Further, the laden Cu might have occupied the original active sites of adsorption catalysis of MnO₂, thereby affecting the effect of catalytic degradation; (2) a large amount of the prepared catalyst is added in the process of catalytic degradation reaction, raising treatment cost and not conducive to the actual engineering application.

Comparison published patent 3: A method for preparing Fe—Co bimetal multi-phase Fenton-like catalyst with modified sepiolite as a carrier. Patent application number: 201210264664.X. In this patent, sepiolite powder is acidified and activated to obtain modified sepiolite. Then urea is added to a ferric nitrate and cobalt nitrate mixed solution and mixed with modified sepiolite. The mixed liquid reacts under the condition of heating in a water bath and then is cooled to obtain precipitate. Then water washing, drying and calcinations are conducted to complete catalyst synthesis. The synthesized catalyst is used to degrade active brilliant blue at an initial concentration of 50 ng/L. After one hour's reaction under the condition of 0.2 mL of hydrogen peroxide and 150 r/min of stirring speed, the removal rate of active brilliant blue reaches about 86.9%. This patent has the following defects in the actual use process: (1) This synthesis method in essence is to precipitate active metal oxide on the internal surface of the sepiolite pore passages by impregnation method. With the progress of catalytic degradation reaction, Fe—Co oxide is liable to falling off from the sepiolite pore passages, resulting in poor stability of the catalyst; (2) After water absorption of sepiolite, its hardness is reduced. After drying, the hardness is resumed. The structure of the laden Fe—Co oxide is changed easily before and after reaction and the dispersibility is reduced. This accelerates the deactivation of the catalyst to some extent.

Comparison published patent 4: A method for preparing iron-laden molecular sieve type Fenton-like catalyst and its application. Patent application number: 201310036533.0. In this patent, 3A molecular sieve is used as a carrier and ferrous sulfate is used as a precursor. By controlling the calcinations temperature of 3A molecular sieve, the added amount of Na₂CO₃ and FeSO₄ in reaction and other parameters, 3A-Fe molecular sieve is obtained and constitutes a heterogeneous Fenton-like system to catalytically degrade nitrobenzene wastewater. This patent has the following defects: (1) In the actual degradation process, a relatively large amount of hydrogen peroxide is added, not conducive to the application in real engineering practice. (2) The synthesized Fe—Na oxide is laden in the pore passages of the molecular sieve. With the progress of the reaction, the oxide will fall off from the surface and pore passages of the molecular sieve, reducing stability of the catalyst.

Comparison published patent 5: A heterogeneous catalyst and application thereof. Patent application number: 201410546489.2. This patent relates to a heterogeneous Fenton-like catalyst of graphene modified mesoporous molecular sieve (MCM-41) complex laden with hematite on the surface. The mesoporous molecular sieve is modified by doping graphene in the mesoporous molecular sieve by in situ synthesis and thermal reduction process to form graphene-mesoporous MCM-41 complex. Then ferric iron is laden on the surface by impregnation method. Through calcinations at high temperature under the protection of a nitrogen atmosphere, ferric salt generates hematite (α-Fe₂O₃) crystal form and ferric oxide-laden graphene-MCM-41 complex is formed. The heterogeneous catalyst synthesized in this patent can effectively reduce the digestion of iron ions in the reaction process, but the degradation of quinoline and phenol need to be conducted in a system of pH=3, so it has the defect that it is unable to play the catalytic action in actual wastewater of which pH value is close to 7. The water sample needs to be acidified, raising the treatment cost of neutral and alkaline wastewater; further, the preparation process of grapheme oxide is complex and the cost is high. Still further, with the progress of reaction and the repeated use of the catalyst, the graphene laden on MCM-41 pore passages may fall off, affecting the even distribution of hematite and the subsequent catalytic effect.

### SUMMARY

### 1. Technical Problems the Present Invention Intends to Solve

The present invention intends to address some common hurdles of the current research and application of Fenton-like technology:

(1) Fenton reaction is a homogeneous reaction directly involved by ions in the solution, so the mass transfer process is fast, but the Fenton-like catalysts researched and developed currently mostly exist in a solid form and the reaction in essence is a catalytic reaction taking place on the interface between solid phase and liquid phase, resulting in large mass transfer resistance in the two-phase reaction process and significant reduction of the reaction speed;

(2) Most of the iron-based metal oxides need a low pH value when they take catalytic reaction as Fenton-like catalysts. They cannot play a catalytic action in actual wastewater of which pH value is close to 7, raising treatment cost of neutral and alkaline wastewater;

(3) The catalyst is not stable and cannot be recycled, causing resource waste to some extent.

Currently, the research on degradation of pollutants by bimetal oxides as Fenton-like reagents and the preparation methods of bimetal oxides is often seen in the literature, but less research has been done on the modification and regulation of the structure of existing substances. The present invention provides a mesoporous manganese ferrite Fenton-like catalyst and its preparation method and application, synthesizes mesoporous molecular sieve KIT-6 under an acidic condition by hydrolysis method by using triblock copolymer as a structure-directing agent and then lades iron salt and manganese salt to the internal pore surface of the molecular sieve by high temperature impregnation method. After calcinations at high temperature, molding of metal oxides is achieved. At last, it is stirred in a strongly alkaline solution to remove template agent KIT-6 and form pores of catalyst manganese ferrite. The catalyst prepared by the present invention and its preparation method enable the pore-formed catalyst particles to have a large exposed specific surface area, provide more adsorption sites and catalytic sites and meanwhile, reduce the mass transfer resistance on the solid-liquid phase interface; the iron ions and manganese ions in manganese ferrite can synergistically participate in and promote double oxidation to generate hydroxyl radical and accelerate the reaction process; in the reaction process, less hydrogen peroxide and catalyst need to be added.

### 2. Technical Solution

The method for preparing mesoporous manganese ferrite Fenton-like catalyst comprises the following steps:

Step (1): dissolve molecular sieve KIT-6, iron salt and manganese salt in an alcoholic solution, reflow under magnetic stirring for 12˜24 h, cool the solution, filter it and dry the filtrate. Here, the molar ratio between iron salt and manganese salt is 0.5-1:2, the alcoholic solution is one, two or three of methanol, ethanol or ethylene glycol and the temperature of magnetic stirring is 70° C. FIG. 3 is a scanning electron microscope (SEM) image of KIT-6, magnified by 20,000 times,

Step (2): Put the foregoing product in a tube furnace, hold temperature at 150-300° C. for 3-5 h, and then hold temperature at 450-600° C. for 3-5 h. Here, the heating rate of the tube furnace is 5˜10° C./min.

Step (3): Stir the post-calcinations product in a NaOH solution for 12-24 h to remove KIT-6 template agent, stir the mixed solution, centrifuge it, wash it with water till the supernate is neutral, and freeze-dry the precipitate. Here, the molar concentration of NaOH is 1-3 mol/L.

### 3. Beneficial Effect

The present invention prepares a mesoporous manganese ferrite Fenton-like catalyst, which has the following advantages over conventional Fenton-like catalysts:

(1) The prepared mesoporous manganese ferrite Fenton-like catalyst has a larger specific surface area and a more obvious mesoporous structure. This structural feature makes the catalytic material have a larger effective contact area for catalytic reaction, thereby providing more adsorption sites and catalytic active sites for the catalytic reaction; further, the mesoporous structure can effectively reduce the mass transfer resistance on the solid-liquid phase interface in the reaction process and accelerate the process of catalytic reaction;

(2) The impregnation method is adopted to mold metal oxide. Then the template agent is dissolved and removed to form pores in the catalytic material, and in the whole preparation process, no other carrier material is introduced. Therefore, the defect of disengagement and drain of catalyst and carrier material is effectively overcome in the process of catalytic reaction;

(3) The prepared mesoporous manganese ferrite Fenton-like catalyst can react with hydrogen peroxide under acidic, neutral and even alkaline (pH=4˜10) conditions to generate hydroxyl radical and efficiently degrade methylene blue wastewater, thereby effectively solving the common hurdle that Fenton reaction can play a role in catalytic degradation of pollutants only under an acidic condition;

(4) The iron ions and manganese ions in the prepared mesoporous manganese ferrite Fenton-like catalyst react with hydrogen peroxide to generate hydroxyl radical to accelerate the reaction process; the multivalence conversion between iron and manganese elements accelerates the migration of electrons on the interface and effectively reduces the digestion of heavy metal ions in the reaction process.

(5) In the reaction process of oxidation water treatment, less hydrogen peroxide and catalyst need to be added.

### BRIEF DESCRIPTION OF THE DRAWINGS

FIG. 1 is a schematic diagram for catalytic degradation of methylene blue by manganese ferrite MnFe₂O₄ of mesoporous Fenton-like catalyst;

FIG. 2 is a N₂ adsorption and desorption curve and a pore diameter distribution diagram of manganese ferrite MnFe₂O₄ of mesoporous Fenton-like catalyst synthesized in Embodiment 3;

FIG. 3 is an SEM image of KIT-6, magnified by 20,000 times;

FIG. 4 is an SEM image of mesoporous manganese ferrite synthesized in Embodiment 1, magnified by 20,000 times;

FIG. 5 is an SEM image of mesoporous manganese ferrite synthesized in Embodiment 2, magnified by 60,000 times;

FIG. 6 is an SEM image of mesoporous manganese ferrite synthesized in Embodiment 3, magnified by 60,000 times;

FIG. 7 is an electron spectrum of mesoporous manganese ferrite synthesized in Embodiment 3;

FIG. 8 is Mn2p spectrum of the electron spectrum of mesoporous manganese ferrite synthesized in Embodiment 3;

FIG. 9 is Fe2p spectrum of the electron spectrum of mesoporous manganese ferrite synthesized in Embodiment 3.

FIG. 10 is XRD patterns of mesoporous manganese ferrite MnFe₂O₄ synthesized in Embodiments 1, 2 & 3.

FIG. 11 is an effect diagram of catalytic degradation of methylene blue by manganese ferrite MnFe₂O₄ in Embodiments 1, 2, 3, 4, 5, 6 & 7.

### DETAILED DESCRIPTION

### Embodiment 1

A method for preparing mesoporous manganese ferrite Fenton-like catalyst, comprising the following steps:

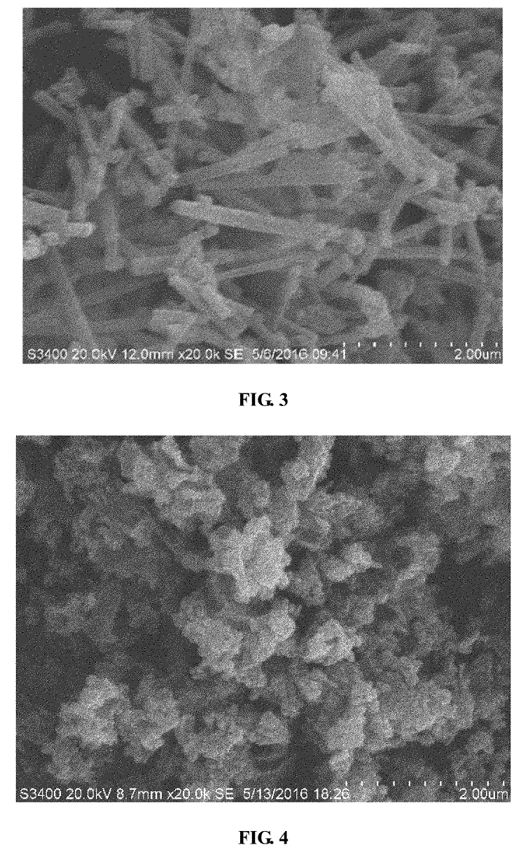

(1) Dissolve molecular sieve KIT-6, FeCl₃.6H₂O and MnCl₂.4H₂O in an alcoholic solution, reflow under magnetic stirring for 12 h, cool the solution, filter it and dry the filtrate. Here, the molar ratio between iron salt and manganese salt is 0.5:2, the alcoholic solution is methanol, and the temperature of magnetic stirring is 70° C. The SEM image of molecular sieve KIT-6 is as shown in FIG. 3.

(2) Put the foregoing product in a tube furnace in an air atmosphere, hold temperature at 200° C. for 3 h, and then hold temperature at 550° C. for 3 h. Here, the heating rate of the tube furnace is 5° C./min.

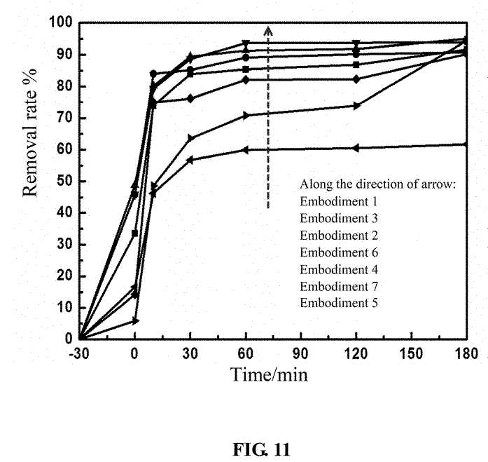

(3) Stir the post-calcinations product in a NaOH solution for 24 h to remove KIT-6 template agent, stir the mixed solution, centrifuge it, wash it with water three times till the supernate is neutral, and freeze-dry the precipitate. Here, the molar concentration of NaOH is 2 mol/L. FIG. 4 is an SEM image of mesoporous manganese ferrite synthesized in this embodiment, and FIG. 10 is XRD patterns of mesoporous manganese ferrite MnFe₂O₄ synthesized in Embodiment 1.

Experiment of Fenton-Like Catalytic Degradation of Methylene Blue:

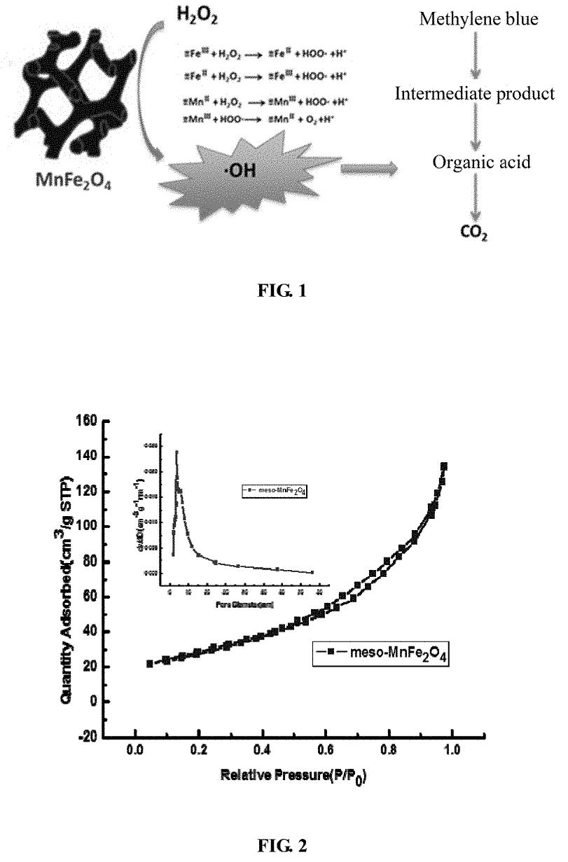

Prepare 200 mL of 20 mg/L methylene blue solution in a conical flask, adjust initial pH value to 4, and add 0.1 g of the prepared mesoporous manganese ferrite. Put the solution in a 25° C. 150 rpm shaking table for adsorption equilibrium for 30 min, then take it out, add 45 mmol/L hydrogen peroxide to form a Fenton-like system for the treatment of oxidation wastewater, take a sample at every quantitative time and determine the concentration of methylene blue. FIG. 1 is an effect diagram for catalytic degradation of methylene blue by manganese ferrite MnFe₂O₄ of mesoporous Fenton-like catalyst in Embodiment 1: Mn and Fe on the surface of hydrogen peroxide and manganese ferrite take redox reaction to generate .OH, free radical degrades methylene blue into organic acids and other intermediate products in the diffusion layer on or near the surface of iron oxides, and eventually degrades it into carbon dioxide and water. The treatment result is shown in FIG. 11. Under an acidic condition, the degradation rate of methylene blue within 60 min by the material synthesized in Embodiment 1 is about 55%.

### Embodiment 2

(1) Dissolve molecular sieve KIT-6, Fe(NO₃)₃.9H₂O and Mn(NO₃)₂.4H₂O in an alcoholic solution, reflow under magnetic stirring for 16 h, cool the solution, filter it and dry the filtrate. Here, the molar ratio between iron salt and manganese salt is 0.75:2, the alcoholic solution is methanol, and the temperature of magnetic stirring is 80° C.

(2) Put the foregoing product in a tube furnace in an air atmosphere, hold temperature at 300° C. for 4 h, and then hold temperature at 600° C. for 4 h. Here, the heating rate of the tube furnace is 10° C./min.

(3) Stir the post-calcinations product in a NaOH solution for 12 h to remove KIT-6 template agent, stir the mixed solution, centrifuge it, wash it with water three times till the supernate is neutral, and freeze-dry the precipitate. Here, the molar concentration of NaOH is 3 mol/L. FIG. 5 is an SEM image of mesoporous manganese ferrite synthesized in this embodiment, and FIG. 10 is XRD patterns of mesoporous manganese ferrite MnFe₂O₄ synthesized in Embodiment 2.

(4) Experiment of Fenton-like catalytic degradation of methylene blue: Prepare 200 mL of 20 mg/L methylene blue solution in a conical flask, adjust initial pH value to 4, and add 0.1 g of the prepared mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11. Under acidic condition, the degradation rate of methylene blue by the material synthesized in Embodiment 2 is about 80% within 60 min.

### Embodiment 3

(1) Dissolve molecular sieve KIT, Fe(NO₃)₃.9H₂O and Mn(NO₃)₂.4H₂O in an alcoholic solution, reflow under magnetic stirring for 24 h, cool the solution, filter it and dry the filtrate. Here, the molar ratio between iron salt and manganese salt is 1:2, the alcoholic solution is ethanol, and the temperature of magnetic stirring is 70° C.

(2) Put the foregoing product in a tube furnace in an air atmosphere, hold temperature at 200° C. for 5 h, and then hold temperature at 550° C. for 5 h. Here, the heating rate of the tube furnace is 5° C./min.

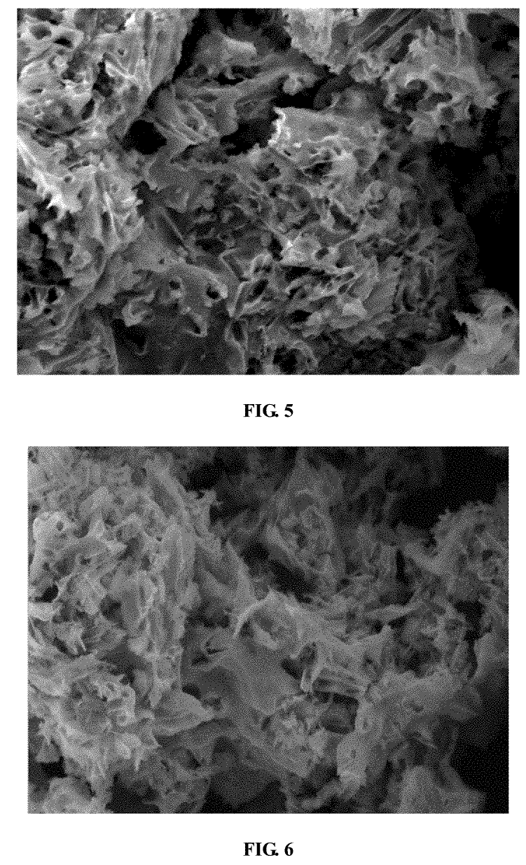

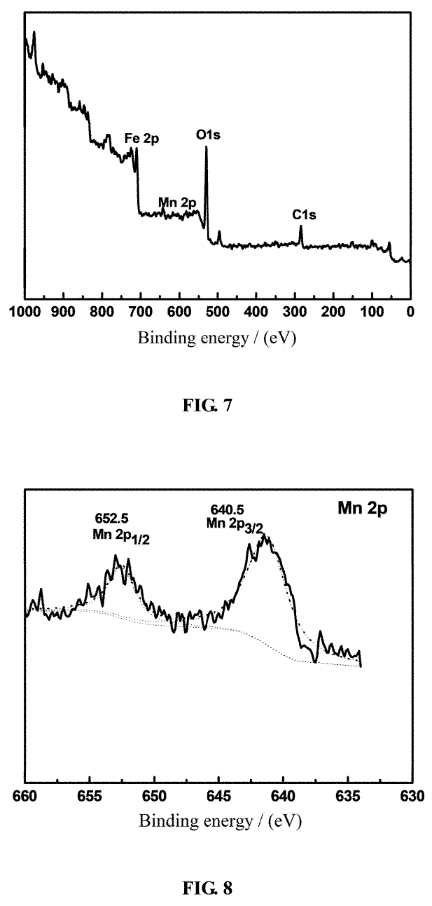

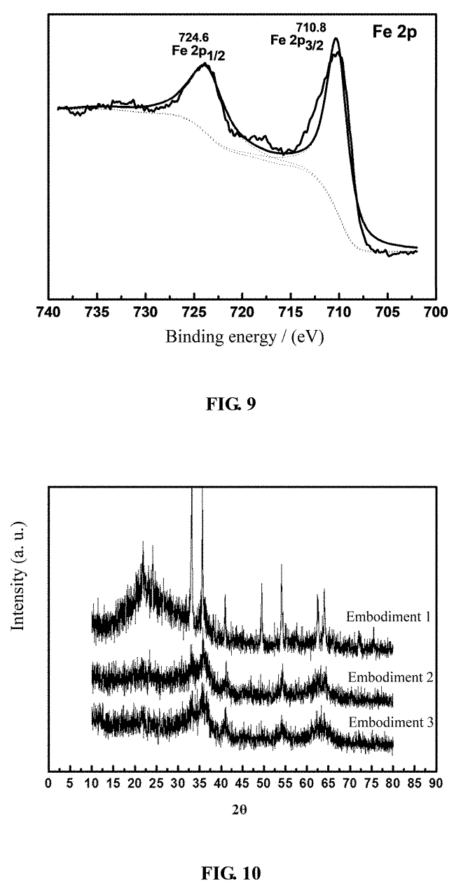

(3) Stir the post-calcinations product in a NaOH solution for 24 h to remove KIT-6 template agent, stir the mixed solution, centrifuge it, wash it with water three times till the supernate is neutral, and freeze-dry the precipitate. Here, the molar concentration of NaOH is 2 mol/L. FIG. 6 is an SEM image of mesoporous manganese ferrite synthesized in this embodiment. FIG. 7 is XPS spectrum of synthesized mesoporous manganese ferrite MnFe₂O₄. FIG. 10 is XRD patterns of mesoporous manganese ferrite MnFe₂O₄ of mesoporous Fenton-like catalyst synthesized in Embodiment 3, and 2θ angles of 29.65°, 34.92°, 42.43°, 52.61° and 61.56° correspond to crystal faces (220), (311), (400), (422), (511) and (440) of manganese ferrite. FIG. 2 is a N₂ adsorption and desorption curve and a pore diameter distribution diagram of the product synthesized in this embodiment, and in BJH calculation model, the specific surface area of mesoporous manganese ferrite is 109.99 m²/g and the mean pore diameter is 3.564 nm. FIG. 8 and FIG. 9 are electron binding energy spectra of Mn 2p and Fe 2p of synthesized mesoporous manganese ferrite. The two peaks at 640.5 eV and 652.5 eV in Mn 2p spectrum correspond to Mn 2p_{3/2} and Mn 2p_{1/2}. The two peaks at 724.6 eV and 710.8 eV in Fe 2p spectrum correspond to Fe 2p_{3/2} and Fe 2p_{1/2}.

TABLE 1
BET result of MnFe₂O₄ synthesized in Embodiment 3:

| | | |
|---|---|---|
| Specific surface area | 109.99 | m²/g |
| Mean pore volume | 0.209 | cm³/g |
| Mean pore diameter | 3.564 | nm |

(4) Experiment of Fenton-like catalytic degradation of methylene blue: Prepare 200 mL of 20 mg/L methylene blue solution in a conical flask, adjust initial pH value to 4, and add 0.1 g of mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11. The diagram shows that under an alkaline condition, the degradation rate of methylene blue by manganese ferritemanganese ferrite within 60 min can exceed 90%.

### Embodiment 4

(1) Dissolve molecular sieve KIT-6, Fe(NO₃)₃.9H₂O and Mn(NO₃)₂.4H₂O in an alcoholic solution, reflow under magnetic stirring for 24 h, cool the solution, filter it and dry the filtrate. Here, the molar ratio between iron salt and manganese salt is 1:2, the alcoholic solution is ethanol, and the temperature of magnetic stirring is 50° C.

(2) Put the foregoing product in a tube furnace in an air atmosphere, hold temperature at 150° C. for 5 h, and then hold temperature at 450° C. for 5 h. Here, the heating rate of the tube furnace is 7° C./min.

(3) Stir the post-calcinations product in a NaOH solution for 16 h to remove KIT-6 template agent, stir the mixed solution, centrifuge it, wash it with water three times till the supernate is neutral, and freeze-dry the precipitate. Here, the molar concentration of NaOH is 1 mol/L.

(4) Experiment of Fenton-like catalytic degradation of methylene blue: Prepare 200 mL of 20 mg/L methylene blue solution in a conical flask, adjust initial pH value to 4, and add 0.1 g of mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11. The degradation rate of methylene blue within 60 min by the manganese ferritemanganese ferrite synthesized under the conditions of Embodiment 4 can exceed 90%.

### Embodiment 5

(1) Dissolve molecular sieve KIT-6, Fe(NO₃)₃.9H₂O and Mn(NO₃)₂.4H₂O in an alcoholic solution, reflow under magnetic stirring for 24 h, cool the solution, filter it and dry the filtrate. Here, the molar ratio between iron salt and manganese salt is 1:2, the alcoholic solution is ethylene glycol, and the temperature of magnetic stirring is 60° C.

(2) Put the foregoing product in a tube furnace in an air atmosphere, hold temperature at 200° C. for 5 h, and then hold temperature at 550° C. for 5 h. Here, the heating rate of the tube furnace is 5° C./min.

(3) Stir the post-calcinations product in a NaOH solution for 24 h to remove KIT-6 template agent, stir the mixed solution, centrifuge it, wash it with water three times till the supernate is neutral, and freeze-dry the precipitate. Here, the molar concentration of NaOH is 2 mol/L.

(4) Experiment of Fenton-like catalytic degradation of methylene blue: Prepare 200 mL of 20 mg/L methylene blue solution in a conical flask, adjust initial pH value to 6, and add 0.1 g of mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11. The diagram shows that under an almost neutral condition, the degradation rate of methylene blue by manganese ferritemanganese ferrite within 60 min can exceed 90%.

### Embodiment 6

(1) Dissolve molecular sieve KIT-6, Fe(NO₃)₃.9H₂O and Mn(NO₃)₂.4H₂O in an alcoholic solution, reflow under magnetic stirring for 24 h, cool the solution, filter it and dry the filtrate. Here, the molar ratio between iron salt and manganese salt is 1:2, the alcoholic solution is ethanol, and the temperature of magnetic stirring is 60° C.

(2) Put the foregoing product in a tube furnace in an air atmosphere, hold temperature at 200° C. for 5 h, and then hold temperature at 550° C. for 5 h. Here, the heating rate of the tube furnace is 5° C./min.

(3) Stir the post-calcinations product in a NaOH solution for 24 h to remove KIT-6 template agent, stir the mixed solution, centrifuge it, wash it with water three times till the supernate is neutral, and freeze-dry the precipitate. Here, the molar concentration of NaOH is 2 mol/L.

(4) Experiment of Fenton-like catalytic degradation of methylene blue: Prepare 200 mL of 20 mg/L methylene blue solution in a conical flask, adjust initial pH value to 8, and add 0.1 g of mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11.

### Embodiment 7

(1) Dissolve molecular sieve KIT-6, Fe(NO₃)₃.9H₂O and Mn(NO₃)₂.4H₂O in an alcoholic solution, reflow under magnetic stirring for 24 h, cool the solution, filter it and dry the filtrate. Here, the molar ratio between iron salt and manganese salt is 1:2, the alcoholic solution is ethanol, and the temperature of magnetic stirring is 60° C.

(2) Put the foregoing product in a tube furnace in an air atmosphere, hold temperature at 200° C. for 5 h, and then hold temperature at 550° C. for 5 h. Here, the heating rate of the tube furnace is 5° C./min.

(3) Stir the post-calcinations product in a NaOH solution for 24 h to remove KIT-6 template agent, stir the mixed solution, centrifuge it, wash it with water three times till the supernate is neutral, and freeze-dry the precipitate. Here, the molar concentration of NaOH is 2 mol/L.

(4) Experiment of Fenton-like catalytic degradation of methylene blue: Prepare 200 mL of 20 mg/L methylene blue solution in a conical flask, adjust initial pH value to 10, and add 0.1 g of mesoporous manganese ferrite. Put the solution in a 25° C. 150 rpm shaking table for adsorption equilibrium for 30 min, then take it out, add 45 mmol/L hydrogen peroxide, take a sample at every quantitative time and determine the concentration of methylene blue. The result is shown in FIG. 11. The diagram shows that under an alkaline condition, the degradation rate of methylene blue by manganese ferritemanganese ferrite within 60 min can exceed 90%.

1. A method for preparing mesoporous manganese ferrite Fenton-like catalytic material, comprising the following steps:
(1) dissolve molecular sieve KIT-6, and iron salt and manganese salt at a molar ratio of 0.5-1:2 in an alcoholic solution, reflow under magnetic stirring for 12˜24 h, cool the solution, filter it and dry the filtrate;
(2) put the foregoing product obtained from filtration in a tube furnace, hold temperature at 150-300° C. for 3-5 h, and then hold temperature at 450-600° C. for 3-5 h;
(3) stir the product obtained after calcinations at step (2) in a NaOH solution for 12-24 h to remove KIT-6 template agent, stir the mixed solution, centrifuge it, wash it with water till the supernate is neutral, and freeze-dry the precipitate.

2. The method for preparing mesoporous manganese ferrite Fenton-like catalytic material according to claim 1, wherein the alcoholic solution at step (1) is methanol, ethanol or ethylene glycol, and the heating temperature under magnetic stirring is 50˜80° C.

3. The method for preparing mesoporous manganese ferrite Fenton-like catalytic material according to claim 1, wherein the heating rate in the tube furnace at step (2) is 5˜10° C./min.

4. The method for preparing mesoporous manganese ferrite Fenton-like catalytic material according to claim 1, wherein the molar concentration of NaOH at step (3) is 1˜3 mol/L.

5. The method for preparing mesoporous manganese ferrite Fenton-like catalytic material according to claim 1, wherein the iron salt at step (1) is Fe(NO₃)₃.9H₂O or FeCl₃.6H₂O, and the manganese salt is Mn(NO₃)₂.4H₂O or MnCl₂.4H₂O.

6. A mesoporous manganese ferrite Fenton-like catalytic material prepared by the method as in claim 1, wherein it is constituted by metal oxides of MnFe₂O₄ and the surface morphology is mesoporous structure.

7-8. (canceled)

9. A mesoporous manganese ferrite Fenton-like catalytic material prepared by the method as in claim 3, wherein it is constituted by metal oxides of MnFe₂O₄ and the surface morphology is mesoporous structure.

10. The mesoporous manganese ferrite Fenton-like catalytic material according to claim 6, wherein the specific surface area is 109.99 m²/g, the mean pore diameter is 3.564 nm and the mean pore volume is 0.209 cm³/g.

11. The mesoporous manganese ferrite Fenton-like catalytic material according to claim 9, wherein the specific surface area is 109.99 m²/g, the mean pore diameter is 3.564 nm and the mean pore volume is 0.209 cm³/g.

12. A Fenton-like system constituted by the mesoporous manganese ferrite Fenton-like catalytic material as in claim 6 and hydrogen peroxide and used to treat oxidation wastewater.

13. A Fenton-like system constituted by the mesoporous manganese ferrite Fenton-like catalytic material as in claim 9 and hydrogen peroxide and used to treat oxidation wastewater.
